(19) United States
(12) Patent Application Publication
(10) Pub. No.: US 2010/0104746 A1
(43) Pub. Date: Apr. 29, 2010

(54) SYSTEMS AND METHODS FOR TREATING RAW MATERIALS FOR WOOD PRODUCT INFORMATION

(75) Inventors: Jack G. Winterowd, Puyallup, WA (US); Cheng Zhang, Seattle, WA (US); Erik M. Parker, Meridian, ID (US)

Correspondence Address: WEYERHAEUSER COMPANY;INTELLECTUAL PROPERTY DEPT., CH 1J27, P.O. BOX 9777, FEDERAL WAY, WA, 98063, US

(73) Assignee: WEYERHAEUSER NR COMPANY, FEDERAL WAY, WA (US)

(21) Appl. No.: 12/638,840

(22) Filed: Dec. 15, 2009

Related U.S. Application Data
(62) Division of application No. 11/239,806, filed on Sep. 30, 2005.

(51) Int. Cl. B05D 5/10

(52) U.S. Cl. 427/207.1

(57) ABSTRACT

Systems and methods for treating raw materials for formation into a wood product are provided. The raw materials may be, for example, strands, flakes, particles, wafers, or the like. In an embodiment, a first dispensing device dispenses a first liquid component onto raw materials within a chamber. A second dispensing device dispenses a second liquid component onto the raw materials. When the raw materials are mixed together, the first and second liquid components interact to form a bonding agent.

### CROSS-REFERENCE TO RELATED APPLICATION

This application is a divisional of and claims the benefit of priority under 35 U.S.C. §120 from U.S. patent application Ser. No. 11/239,806, filed on Sep. 30, 2005, and titled “Systems and Methods for Treating Raw Materials for Wood Product Formation,” the contents of which are incorporated herein by reference.

### TECHNICAL FIELD

The present disclosure generally relates to systems and methods for treating raw materials, such as, for example, strands, particles, chips, fiber, flour, or the like, for wood product formation. The raw materials are treated with adhesive components that can be applied separately. Subsequent to application, the components mix and react or otherwise associate within the matrix of raw materials and/or the surface of the raw materials to form a new bonding adduct.

### BACKGROUND

Engineered panels are formed from raw materials which are pressed and heated to form a wood or wood-containing product. The raw materials may be, for example, strands, chips, wafers, fiber, flour, particles, or the like. Composite panels, such as oriented strandboard (OSB), flakeboard, waferboard or TimberStrand® laminated lumber, are generally comprised of bonding resin (adhesive), wax and wooden strands. These products are typically manufactured in seven major stages, which include stranding, screening, drying, blending, forming, pressing, and finishing.

Stranding is a process in which logs are cut into discrete wooden strands (also known as flakes) that typically have an aspect ratio between 1 and 20. The long axis of the strands is predominantly aligned within about 0-30 degrees of the grain of the wood. The strand thickness can range from about 0.015″ to about 0.050″ and the length can range from about 1″ to about 12″, or even longer. In most cases, it is advantageous to cut strands from wood that has a relatively high moisture content, such as 30-200%. Thus, the stranding process almost always yields wet strands that must be dried prior to further processing.

Drying is usually accomplished by passing the wet strands through long rotating drums or pipes in conjunction with hot, dry air. Alternatively, strands can be dried by conveying them in a chamber with hot, dry air passing through or around the conveyance system. The drying process commonly results in strands that have a moisture content of about 1-7%. The resulting dried strands exist as a mixture of relatively large and small elements, and it is frequently desirable to screen the material in order to separate the strands on the basis of size. In many cases the smallest wooden particles, known as fines, are diverted from the product stream and are transported to a burner where they are used as fuel.

The acceptable wooden strands are then metered into large rotating drums, known as blenders, and are sprayed or otherwise mixed with bonding resin and wax. This stage is known as blending. Many blenders rotate at a rate of about 4-20 rpm and are tilted)(3-8° in order to promote material flow. A single blender can have about six liquid application devices, or “applicators”, distributed within it. Such application devices are frequently rotary disk atomizers, but they can also be spray guns, or like devices. In some cases, one of the application devices may be, for example, devoted to dispensing wax and five of the application devices may be devoted to dispensing resin. In some cases, powdered bonding resins can be introduced into the blender. It is common for large strands and small strands to be blended separately.

Strands that have been treated with bonding resin and wax are then formed into a mat. In the case of OSB and TimberStrand® laminated lumber, treated strands are formed into a mat by dispensing them at a controlled rate through mechanical partitions that tend to align the strands in a particular orientation. As the strands pass through the alignment devices they are collected onto a continuous conveyor belt. In the case of waferboard, the strand alignment devices are not used, and the mat that collects on the conveyor belt has an essentially random orientation within the plane of the mat parallel to the conveyor belt. Frequently, the strands incorporated into the top and bottom layers of an OSB mat are larger than the strands incorporated into the core (or middle) layer of the mat. In many cases the bonding resins and application levels used in the surface layers of an OSB mat are different than those used in the core layer of the mat. In a commercial manufacturing process, the mat is generally continuous in length and has a width of between about 4′ and 16′. The thickness of the mat can be in the range of about 2″ to 20″. In some cases the continuous mat of treated strands is transported directly into a continuous hot-press, but in most cases the mat is cut into discrete sections, which commonly have a length of about 8′ to 20′. These mat sections are loaded into a multi-opening hot press, which can usually press between 12 and 20 mats simultaneously. In the case of TimberStrand® laminated lumber, the mat is loaded into a single-opening steam-injection press.

During the process of pressing, strands are forced together and intimate contact is achieved along their interface. Subsequent to this consolidation process, bond formation occurs as the resin undergoes curing reactions and is converted from a liquid to a load-bearing solid. The press then opens and the relatively large “jumbo” panels are ejected onto a conveyor and transported to the finishing stages of the operation.

Finishing steps commonly include cutting the jumbo panels into smaller panels, such as those having dimensions of 4 feet×8 feet. Other finishing activities can include sanding, edge profiling, marking with grade stamps, grading for quality, stacking into units, sealing, labeling, strapping and packaging.

Many wood-based composite panels are produced by use of so-called one-component adhesives, which are simply mixed with the strands without modification and eventually result in the formation of bonds between the strands during pressing. Thus, one-component adhesives are relatively simple and convenient to use. Examples of one-component adhesives that are commonly used to manufacture wooden strand-based composite panels include polymeric diphenylmethane diisocyanate (pMDI), such as Huntsman's Rubinate 1840; liquid phenol/formaldehyde resole resins, such as Georgia-Pacific's 70CR66 resin; and powdered phenol/formaldehyde resole resins, such as Hexion's (formerly Borden) W3154N resin. The curing action of one-component adhesives, especially phenol/formaldehyde adhesives, is predominantly triggered by elevated temperature. This behavior makes them suitable for the wooden strand-based composite panel manufacturing process in which a long shelf-life at room temperature is required in conjunction with a fast cure rate during pressing. Although it is somewhat of an oversimplification, the following equation can be used to generally represent the relationship between temperature and the initial rate at which curing reactions would occur in a hypothetical single-component adhesive comprised of just one reactant compound:

Initial reaction rate: Initial rate of curing reaction=Δ[reactant]/Δt=[reactant]^{a}Ae^{(-E/RT)} where: Equation 1.

Δ[reactant]/Δt=the change in the concentration of reactant with respect to time;

a=the order of the reaction, which must be experimentally determined, but in many cases 1≦a≦2;

A=the so-called Arrhenius parameter, which increases only slightly as the temperature increases, and for the sake of illustration can be treated as a constant;

E=the energy of activation for the reaction, which is generally treated as a constant for a particular reaction;

R=the gas constant (8.314 J/° K. mol); and

T=absolute temperature, expressed in degrees Kelvin.

Review of Equation 1 helps to demonstrate some interesting characteristics associated with one-component adhesives, especially phenol/formaldehyde one-component adhesives. For example, so-called room-temperature is approximately 298° K. Thus, the adhesive is actually curing at room temperature, although the rate is relatively slow. Many liquid phenol/formaldehyde resole resins have a shelf-life at room temperature of about 4 weeks. Beyond this point, these resins have cured to an extent that they are typically too viscous to appropriately spray onto strands.

It is common for the temperature of the core of wood-based composite mats to quickly rise to about 110° C. (383° K.). Some phenol/formaldehyde resole resins used in the wood-based composite panel industry behave as if they had an energy of activation value, E˜120,000 J/mol. Using Equation 1, it can be shown that such resins achieve similar degrees of cure after being stored at room temperature for 4 weeks as they do when they are maintained at a temperature of 110° C. for a period of 0.87 minutes. Thus, the initial cure rate of some phenol/formaldehyde resole resins is about 46,600 times faster at 110° C. than it is at 25° C.

Thus, liquid phenol/formaldehyde resole resins exhibit relatively long shelf-life values at room temperature and relatively fast cure rates at elevated temperatures. Nevertheless, there are cases in which strand-based composite panel manufacturers would benefit from the use of bonding resins that have longer shelf-life at room temperature, and faster cure rates during hot-pressing.

As previously mentioned, pMDI is also used as a bonding resin in the production of wooden strand-based composite panels. This resin tends to exhibit longer shelf life at room temperature as long as it is kept dry, and faster cure rates during hot-pressing, as compared to phenol/formaldehyde resins. These advantages are largely attributed to a unique curing mechanism in which the pMDI reacts with water (and perhaps other compounds) in the wooden strands to form aromatic polymers with urea linkages. Thus, the predominant curing action of pMDI is triggered by its exposure to the wooden strands. Interestingly, the curing reactions of pMDI in the presence of water are substantially less dependent on temperature than the curing reactions of phenol/formaldehyde resins. The energy of activation, E, for the pMDI/water reaction appears to be about 63,000 J/mol.

In addition to longer shelf-life and faster curing rates, pMDI also tends to yield fewer steam-blows, which can occur at the completion of the hot-pressing process when the press opens and steam pressure within the mat exceeds the strength of the strand-to-strand bonds. Thus, steam-blows tend to occur when the strength of the strand-to-strand bonds is relatively low and the internal steam pressure in the panel is relatively high. Obviously, panels manufactured with steam-blows are defective and must be rejected or down-graded. Thus, the occurrence of steam-blows adversely affects production rates. The steam pressure inside the strand mat is dependent upon the moisture content of the mat, and since liquid phenol/formaldehyde resole resins contain about 40-50% water and pMDI contains no water, the steam pressure in a mat based on a liquid phenol/formaldehyde resole resin tends to be greater than one based on pMDI.

Although pMDI has some substantial processing advantages, it is currently priced higher than that of the liquid phenol/formaldehyde resole resins. In an effort to capture the processing benefits associated with the use of pMDI at a reduced cost, a number of two-component adhesive systems, which are comprised of pMDI and a second component, have been developed. The second component is a compound that is reactive with pMDI. These two-component systems have been designed to be mixed together at certain ratios. This can be accomplished with meter-mixing equipment, which continuously combines and mixes two or more liquid components at a specified ratio. This equipment is commercially available from companies such as the Willamette Valley Company. Generally, the mixture of pMDI and the second component exhibits an increase in viscosity soon after being combined. As long as the mix ratio of the two components is within a certain critical range, the mixture will eventually solidify through curing reactions, even at room temperature. Thus, it is vital for the mixed material to be dispensed onto the strands within a relatively short period of time. One example of a second component that has been specifically developed to be meter-mixed with pMDI to form a lower cost bonding mixture for strand-based composite panels is a proprietary liquid formulation, known as “CB3000” from the Ashland Specialty Chemical Company.

U.S. Pat. Nos. 6,214,265 and 6,641,761 describe two-component adhesive systems comprised of isocyanates (including pMDI) and solid phenol/formaldehyde resole resins for OSB and other wood-based composite products.

U.S. Pat. Nos. 6,294,117 and 6,641,762 describe two-component adhesive systems comprised of isocyanates (including pMDI) and solid phenol/formaldehyde novolac resins for OSB and other wood-based composite products.

Each of these patents teaches the art of combining isocyanate resin with solid phenol/formaldehyde resin to form a mixture, which is then applied to wooden elements as an adhesive. These patents also state that it is possible, but not recommended, to first apply pMDI to the strands or other wooden elements in the panel and then to apply the powdered phenol/formaldehyde resin. Unfortunately, in this situation the pMDI is rapidly absorbed into the wood while the phenol/formaldehyde resin particles remain on the outside of the wood. Thus, there is little opportunity for the two different components to react and thereby generate a synergistic effect.

U.S. Pat. No. 5,128,407 describes a two-component adhesive system comprised of polyisocyanates and an aqueous urea solution which can be mixed and applied to wooden elements in the production of various wood based composites. Such mixtures are known to cure at room temperature within a short period of time.

U.S. Pat. No. 6,416,969 describes an aqueous mixture of blocked pMDI and phenol/formaldehyde resole resin. The mixture has a claimed shelf-life equal to or superior to that of the phenol/formaldehyde resin. Thus, this two-component resin system would not be expected to prematurely cure prior to application to the strands. Unfortunately, the resin mixture contains significant amounts of water and it does not seem to perform any better than conventional phenol/formaldehyde resole resins. Also, the blocking agents required to achieve the long shelf life are not commercially available.

The concept of reactive, two-component adhesive systems for strand-based composite panels is not limited to those based on pMDI. U.S. Pat. No. 5,700,587 describes a resorcinol-glutaraldehyde “accelerator”, which can be combined with phenol/formaldehyde resole resins to form a binder mixture for strands in OSB. The patent states that mixtures of the resorcinol-glutaraldehyde resin and phenol/formaldehyde resole resins that are commonly used to make OSB have a shelf life at room temperature of about 30-60 minutes or less.

In spite of the potential advantages of two-component adhesive formulations in conjunction with meter-mix technology, these systems are not commonly used in the wooden strand-based composite panel industry. Unfortunately, work conducted in an actual production environment has demonstrated that there is a tendency for the adhesive mixture to prematurely cure and even solidify in hoses or pipes prior to being dispensed onto the strands. In some cases, this situation can necessitate the replacement of large portions of the plumbing and application system.

### BRIEF DESCRIPTION OF THE DRAWINGS

The embodiments of the present disclosure are described in detail below with reference to the following drawings.

FIG. 1 is a chart of viscosity versus time for a bonding agent system of components in an embodiment of the present disclosure;

FIG. 2 is a diagram of a system for treating raw materials for wood product formation in an embodiment of the present disclosure;

FIG. 3 is a diagram of a system for treating raw materials for wood product formation in another embodiment of the present disclosure; and

FIG. 4 is a diagram of a system for treating raw materials for wood product formation in another embodiment of the present disclosure.

### DETAILED DESCRIPTION

Specifically, this disclosure relates to a method in which individual liquid adhesive components are separately applied to raw materials for wood product formation, such as, for example, strands, flour, flakes, fibers, wafers, chips, or the like, without pre-mixing, during the process of producing engineered wood panels. An adhesive system suitable for this disclosure may be comprised of two or more components. In an embodiment, one of the components is a stable, low-viscosity, liquid that contains 10% or more of a compound with multiple isocyanate functional groups. A second component may be a stable, low-viscosity, liquid that contains 10% or more of an aliphatic compound with multiple nucleophilic functional groups. In an embodiment, the aliphatic compound has a molecular weight of less than approximately 1500 g/mole. The adhesive system prevents, for example, premature curing and line-plugging which may be encountered when reactive, plural-component adhesive systems are mixed prior to application to raw materials.

A class of individual liquid adhesive components may be applied separately to the raw materials. Subsequent to application the different components may mix spontaneously and react or otherwise associate within a wooden matrix, such as within a blender, to form a new bonding agent or adduct that performs in a manner similar to that of neat pMDI at a reduced cost. It is theorized that these particular liquid adhesive components are mutually soluble in the wooden matrix of the raw materials. Thus, the wooden matrix may promote intimate mixing of the components on a molecular level even in cases of uneven distribution.

Compounds with multiple isocyanate functional groups may include, but are not limited to, aromatic polyisocyanates, such as 2,4′-methylene bis(phenylisocyanate), 4,4′-methylene bis(phenylisocyanate), pMDI, which is a mixture of MDI and MDI oligomers, and 1,5′-naphthalenediisocyante. Aliphatic polyisocyanates such as hexamethylene diisocyanate and isophorone diisocyanate and blocked polyisocyanates are also suitable for this disclosure. Stable liquids that contain 10% or more of the compound with multiple isocyanate functional groups may be neat isocyanates, such as pMDI or solutions of isocyanates in solvents, such as propylene carbonate or triacetin. The term “stable liquid” refers to a liquid that can be stored for approximately seven days at a temperature of 25° C. without undergoing phase separation or increasing in viscosity to a level that would be unsuitable for spray or atomization application techniques. Liquid viscosity values that are appropriate for spraying are those less than approximately 400 cps as determined by use of a Brookfield Viscometer using a #3 spindle at a rotation rate of 20 rpm, at a temperature of 25° C.

Aliphatic compounds with multiple nucleophilic functional groups and a molecular weight less than 1500 g/mole may include, but are not limited to, compounds with multiple alcohol and/or amine and/or mercaptan functionality. Specific examples may include triglycerides of ricinoleic acid, which occurs abundantly in castor oil; certain amino acids such as lysine, serine, cysteine and threonine; certain saccharides, such as glucose, fructose and sucrose; ethylene glycol; glycerol; triethanolamine; diethanolamine; ethanolamine; hexanediol; hexamethylenediamine; and low-molecular-weight adducts of formaldehyde and urea.

Stable liquids that contain 10% or more of an aliphatic compound with multiple nucleophilic functional groups can be the neat nucleophilic compound in those cases in which said compound is a liquid. In the alternative, they can be solutions of said compound in solvents such as water. It is also within the scope of this disclosure to use liquids comprised of mixtures of aliphatic compounds with multiple nucleophilic functional groups and molecular weights less than 1500 g/mole.

The individual components of the adhesive system can be applied to wooden strands by conventional liquid application equipment. In an embodiment, a first component is sprayed onto the raw materials. A second component is then sprayed onto the raw materials. The raw materials may or may not be mixed or blended after application of the first component, and may or may not be mixed or blended after application of the second component. The components may become deposited within the matrix of the raw materials as well as on the surface. Interaction between the raw materials after application of the second component may cause contact between the first component and second component. The first component and the second component may then react or otherwise associate to form a bonding agent. The bonding agent may be present on a surface of the raw materials and/or within the matrix.

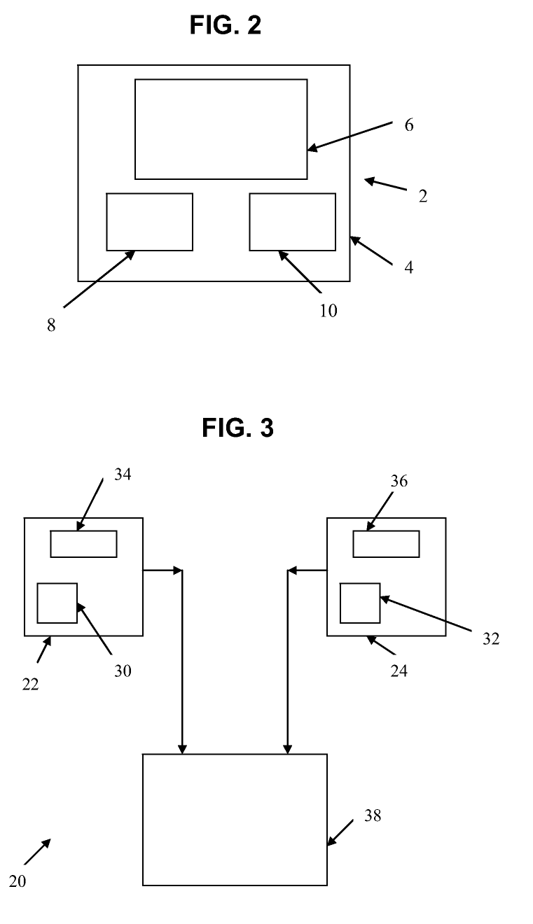

FIGS. 2 and 3 illustrate different systems 2, 20 through which the components may be dispensed. In the system 2 of FIG. 2, a chamber 4 may house raw materials 6. The chamber 4 may be, for example, a blender or other container for housing raw materials typically used in engineered wood product formation. The chamber 4 may have one or more dispensing devices 8, 10 for dispensing liquid components onto the raw materials 6. The term dispensing device should be construed to mean any type of device or system used to dispense liquid components including, but not limited to, spray guns, rotary disk atomizers, such as spinning disk atomizers produced by Coil Manufacturing Ltd, or the like. The dispensing device 8 may dispense elements of a first liquid component and the dispensing device 10 may dispense elements of a second liquid component for forming the bonding agent.

As previously mentioned, it is common for a single blender to contain five applicators that are devoted to bonding resin. In an embodiment, each applicator is exclusively devoted to one of the adhesive components. For example, in a particular blender, three spinning disk atomizers might be used to dispense pMDI, while the remaining two spinning disk atomizers are used to dispense castor oil. The sequence of the resin dispensing sites is not limited in this disclosure, although some sequences might work better than others. Also, the disclosure is not limited to blenders that contain five resin applicators. It is within the scope of this disclosure for a blender to have two or more resin applicators with one or more applicators being used for one of the adhesive components and the balance of applicators being used for the other adhesive component. Further, it is within the scope of this disclosure for raw materials to be processed through a series of blenders with different adhesive components being applied to the strands in each blender. This embodiment is seen in FIG. 3. More specifically, the system 20 of FIG. 3 may have chambers 22, 24 which house raw materials 34, 36, respectively. The raw materials 34, 36 may be treated by dispensing devices 30, 32 separately. The treated raw materials 34, 36 may then be transported to a blender 38 or other chamber for mixing. Each component of the adhesive system may be separately applied to the strands so that multiple adhesive components do not have an opportunity to react or otherwise associate with each other until after each has been applied to the wooden substrate.

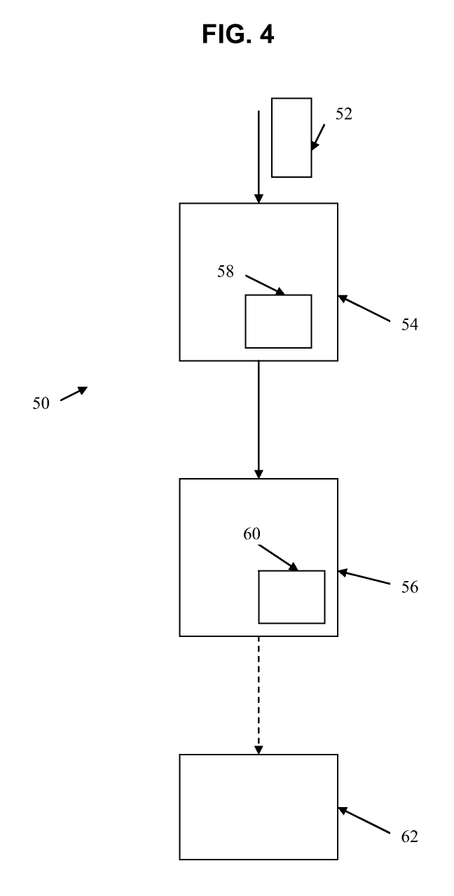

FIG. 4 illustrates another system 50 in which a single set of raw materials 52 are transported to separate chambers such as blenders 54, 56 for dispensing of components. In the first blender 54, a dispensing device 58 may dispense a first component of, for example, an adhesive system. The raw materials 52 may then be transported to the second blender 56 in which a dispensing device 60 may dispense a second component of the adhesive system. Interaction of the components may occur in the second blender 56. In an alternate embodiment, the raw materials 52 may be sent to a separate chamber 62 to be mixed, thus enabling interaction between components to form a bonding agent. It should be understood that the number of chambers or blenders is not limited to those shown in FIG. 4 but may be any number required for dispensing of components.

Proportioning the levels of the different components can be controlled by simply adjusting the dosing rate of each adhesive component relative to the mass flow of the raw materials. Individual adhesive component application levels can generally range from about 0.1-20.0% of the dry weight of the wood. Typically, individual adhesive component application levels will range from about 0.5-8.0% of the dry weight of the wood.

The present disclosure can be utilized on various types of raw materials. In the case of strands, the components may be dispensed onto strands destined for the core layer of the panel, or the surface layer of the panel, or both the surface and the core layer of the panel. Panel types appropriate for this disclosure may be any type of engineered wood product including, but not limited to, oriented strandboard, flakeboard, waferboard particle board, laminated veneer lumber, chip board, TimberStrand® laminated lumber, or the like. Moreover, wood products, such as composites of wood and other materials, such as plastic, may also be within the scope of this disclosure.

The disclosure and the associated advantages are further illustrated by the following examples:

### Example 1

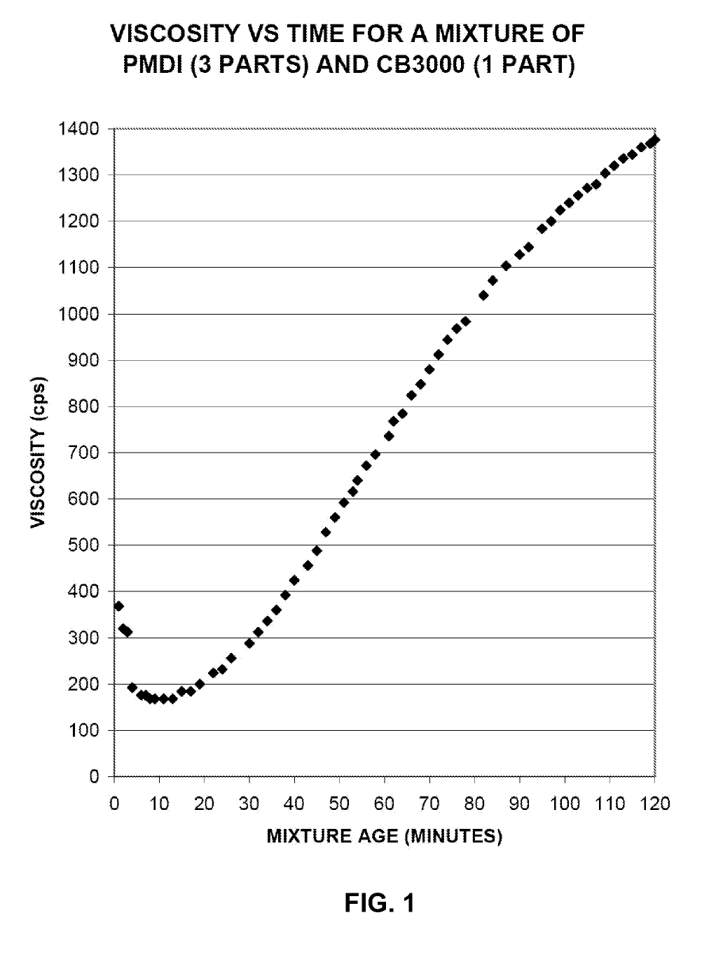

A mixture of pMDI, known as Lupranate M20SB produced by BASF (375.0 g, initial temperature=29.4° C.) and CB3000 produced by the Ashland Specialty Chemical Company (125.0 g, initial temperature=15.6° C.) was prepared and monitored for viscosity for the first 120 minutes while suspended in a water bath that was maintained at a temperature of 26.7° C. The measurements were conducted by use of a Brookfield Viscometer using a #2 spindle and a constant rotation rate of 10 rpm. The results are provided in FIG. 1.

### Example 2

Oriented strandboard panels (24″×24″×0.72″, 38 pcf) were prepared in a laboratory. All panels were made using aspen strands with a maximum length of about 3″ and an average thickness of about 0.028″. The strands were dried to a moisture content of approximately 5% and screened to remove material smaller than 1/8″. Strands used for the core layers of the panels were similar in size distribution to those used for the surface layers. All strands (surface and core layer) were sprayed with molten slack wax, known as PDU600 produced by the ExxonMobil Chemical Company, at a level of 1.0% relative to the dry mass of the strands. Bonding resin was applied to all strands at a level of 6.0% relative to the dry mass of the strands. The composition of the bonding resin and the technique used to mix the components are shown in Table 1. The ratio of the mass of the surface and core layers was 50:50, and the strand orientation in each of these layers was essentially perpendicular to each other. Panels were pressed within 1 hour of blending. The press cycle included a 60 s closing time, 190 s at final position and a 30 s decompression step. Platen temperature was 200° C. and each panel was post-cured in a hot box for 12-20 hours. Each panel type was conditioned at 50% R.H. and a temperature of 21° C. and tested for internal bond strength in a dry state.

TABLE 1
Bonding resin and internal bond strength of lab panels

| | TECHNIQUE USED | DRY INTERNAL | |
|---|---|---|---|
| BONDING RESIN | TO MIX ADHESIVE | BOND STRENGTH | |
| COMPOSITION | COMPONENTS | (PSI) | |
| pMDI (6.0%) | not applicable | 134.2^{ab} | (32.6) |
| pMDI (4.5%) + castor | mixed prior to | 139.9^{a} | (25.1) |
| oil (1.5%) | application to strands | | |
| pMDI (4.5%) + castor | each component applied | 119.6^{b} | (20.0) |
| oil (1.5%) | separately to strands | | |
| pMDI (4.5%) + CB3000 | each component applied | 123.3^{ab} | (18.1) |
| (1.5%) | separately to strands | | |

Note:
each average internal bond strength value is based on 12 specimens (6 each from 2 panels). Numbers shown in parenthesis are standard deviation values. Any two average strength values that do not share a common superscript were found to be significantly (p < 0.05) distinct.

While the embodiments of the disclosure have been illustrated and described, as noted above, many changes can be made without departing from the spirit and scope of the disclosure. Accordingly, the scope of the disclosure is not limited by the disclosure of the embodiments. Instead, the disclosure should be determined entirely by reference to the claims that follow.

I/We claim:

1. A method for treating raw materials for wood product formation, the method comprising the steps of:
dispensing a first liquid component onto the raw materials, wherein the first liquid component comprises 10% or more of a compound with multiple isocyanate functional groups; and
dispensing a second liquid component onto the raw materials;
wherein contact between the first liquid component and the second liquid component causes formation of a bonding agent.

2. The method of claim 1 wherein the raw materials are selected from a group consisting of strands, flakes, flour, particles, chips, wafers, fibers and veneers.

3. The method of claim 1 wherein the compound is an aromatic polyisocyanate.

4. The method of claim 1 wherein the compound is an aliphatic polyisocyanate.

5. The method of claim 1 wherein the second liquid component comprises approximately 10% or more of an aliphatic compound with multiple nucleophilic functional groups.

6. The method of claim 5 wherein the aliphatic compound has a molecular weight of less than about 1500 g/mole.

7. The method of claim 1 wherein the step of dispensing the first liquid component is performed by a first dispensing device and the step of dispensing the second liquid component is performed by a second dispending device.

8. The method of claim 1 wherein the second liquid component is castor oil.

9. The method of claim 1 wherein the first liquid component is polymeric diphenylmethane diisocyanate.

10. A method for treating raw materials for wood product formation, the method comprising the steps of:
dispensing a first liquid component onto the raw materials, the first liquid component comprising 10% or more of an aliphatic compound with multiple nucleophilic functional groups; and
dispensing a second liquid component onto the raw materials;
wherein contact between the first liquid component and the second liquid component causes formation of a bonding agent.

11. The method of claim 10 wherein the second liquid component comprises 10% or more of a compound with multiple isocyanate functional groups.

12. The method of claim 10 wherein the aliphatic compound has a molecular weight less than 1500 g/mole.

13. The method of claim 10 wherein the raw materials are selected from a group consisting of strands, flakes, particles, chips, wafers, fibers and veneers.

14. The method of claim 10 wherein the step of dispensing the first liquid component is performed by a first dispensing device and the step of dispensing the second liquid component is performed by a second dispensing device.

15. A method for treating raw materials for wood product formation, the method comprising the steps of:
providing one or more chambers;
dispensing a first liquid component onto the raw materials in the one or more chambers, wherein the first liquid component comprises 10% or more of a compound with multiple isocyanate functional groups; and
dispensing a second liquid component onto the raw materials in the one or more chambers, wherein the second liquid component comprises 10% or more of an aliphatic compound with multiple nucleophilic functional groups;
wherein contact between the first liquid component and the second liquid component causes formation of a bonding agent; and
wherein the raw materials are selected from a group consisting of strands, flakes, flour, particles, chips, wafers, fibers and veneers.

16. The method of claim 15 wherein the second liquid component is castor oil and the first liquid component is polymeric diphenylmethane diisocyanate.

17. The method of claim 15 wherein the step of dispensing the first liquid component is performed by one or more first applicators and the step of dispensing the second liquid component is performed by one or more second applicators.

18. The method of claim 15, further comprising the step of mixing the raw materials in the one or more components or in a blender.

19. The method of claim 15 wherein:
the step of dispensing the first liquid component onto the raw materials in the one or more chambers further comprises dispensing the first liquid component onto the raw materials in a first chamber or a first blender; and
wherein the step of dispensing the second liquid component onto the raw materials in the one or more chambers further comprises dispending the second liquid component onto the raw materials in a second chamber or a second blender.

20. The method of claim 19, further comprising mixing the raw materials in a third chamber or a blender.
